(19) United States
(12) Patent Application Publication
(10) Pub. No.: US 2010/0126807 A1
(43) Pub. Date: May 27, 2010

(54) Screw elevator

(76) Inventors: Tien-Tzu Liao, Taichung (TW); Chun-Wei Huang, Taichung (TW)

Correspondence Address: Dr. BANGER SHIA;Patent Office of Bang Shia, 102 Lindencrest Ct., Sugar Land, TX, 77479-5201, US

(21) Appl. No.: 12/276,338

(22) Filed: Nov. 22, 2008

(51) Int. Cl. B66B 11/08

(52) U.S. Cl. 187/254

(57) ABSTRACT

A screw elevator comprises a pair of counterweight guide rails, a pair of deflection wheels, a counterweight frame, a screw, a power unit, a cable, a car and a car guide rail. The power unit, the screw and the counterweight frame are all disposed between the pair of counterweight guide rails. The power unit drives the screw and the counterweight frame to move, and then the movement of the screw will drive the cable to make the car move upwards and downwards along the car guide rail. The cable has one end fixed at a position above the counterweight rails and the other end of the cable is finally fixed at the center of the top of the car after being wound around a traction wheel and straddled over the deflection wheels.

### BACKGROUND OF THE INVENTION

1. Field of the Invention

The present invention relates to a screw elevator, and more particularly to a screw elevator which is driven to move using a screw with a length that is half of the travel of the elevator.

2. Description of the Prior Art

A conventional screw elevator, as disclosed in Taiwan Patent No. 1296606, entitled “two-way screw drive mechanism for an elevator”, is provided with a screw and a power unit that are both placed at one side of an elevator car. The power unit includes a motor and a deceleration mechanism and is directly connected with the elevator car. The nut is installed in the deceleration mechanism, and the screw is fixed on the beam structure above the elevator car. When being actuated, the motor will output power to the nut through the deceleration mechanism, so that the nut will move along the screw to drive the elevator car to move synchronously. Furthermore, due to the limitation of the guide shoes installed on the elevator car, the elevator car will linearly move upwards and downwards along the screw.

In the above conventional screw elevator design, the screw and the motor are disposed at a single side of the elevator car, so that when the motor drives the elevator car to move upwards and downwards, the drive force from the motor will act on the single side of car, thus producing a torque on the car. As a result, the car is likely to deform due to the torque, thus affecting the smoothness of the movement of the elevator. In addition, not only does the space of movement of elevator provide the space for the arrangement of the guide rails, but also extra space is needed for installing the screw. Therefore, the difficulty of design and the cost are correspondingly increased. Furthermore, in such a design, the elevator car is designed to directly move on the screw, so that the length of the screw is the travel of the elevator car. Hence, it is found that the screw is too long, thus increasing the difficulty of production. Additionally, since the power unit must employ the deceleration mechanism to obtain the relatively large torque and proper rotating speed to drive the nut, the use and arrangement of the deceleration mechanism not only increases the cost but occupy the space of movement of the elevator.

The present invention has arisen to mitigate and/or obviate the afore-described disadvantages.

### SUMMARY OF THE INVENTION

The primary objective of the present invention is to provide a screw elevator, which employs a power unit to drive the car to move upwards and downwards, wherein the cable is combined at the center of the top of the car, which is just the center of gravity of the car, so that although the principle of screw is applied, the car is subjected to a relatively small torque and shares the pulling fore and weight evenly, thus making the overall elevator more durable and the upward/downward movement of the elevator relatively smooth.

The secondary objective of the present invention is to provide a screw elevator in which the screw is installed within the space of the counterweight guide rails without providing extra installation space, thus making the overall structure layout and design relatively simple and reduce the design and construction cost.

The third objective of the present invention is to provide a screw elevator in which the length of the screw is just half of the total travel of the car, so that the production of the screw elevator of the present invention is more simplified, and the travel of the screw elevator of the present invention is relatively long, thus widening the application range.

The fourth objective of the present invention is to provide a screw elevator in which the power unit includes a motor which is interiorly provided with a motor rotor in which is provided a driving nut to be screwed on the screw, so that the screw elevator of the present invention doesn't require a complicated deceleration mechanism, thus having the advantages such as lower cost of parts, occupying less space, simple design and easy to install.

In order to solve the above technical problems, a screw elevator in accordance with the present invention comprises a pair of counterweight guide rails, a pair of deflection wheels, a counterweight frame, a screw, a power unit, a cable, a car and a car guide rail. The counterweight guide rails are disposed on a fixed wall surface. The deflection wheels are disposed above the counterweight guide rails. The counterweight frame is provided with a traction wheel at a top thereof and further provided with an inner counterweight body. The screw has one upper end fixed at the bottom of the counterweight frame. The power unit is foxed on a wall surface and includes a motor that is assembled with the screw, and the motor is interiorly provided with a motor rotor which is interiorly provided a driving nut to be screwed on the screw, the motor rotor is provided to drive the driving nut to rotate so as to drive the screw to move. The cable has one end fixed at a fixing position above the pair of counterweight guide rails, and the other end of the cable is finally connected to the car after being wound around the traction wheel and straddled over the deflection wheels, and the car is disposed under the deflection wheels and connected to the cable. The car guide rail is disposed on a fixed wall surface parallel to the fixed wall surface fixed with the pair of counterweight guide rails for guiding movement of the car.

### BRIEF DESCRIPTION OF THE DRAWINGS

FIG. 1 is a perspective view of a screw elevator in accordance with the present invention;

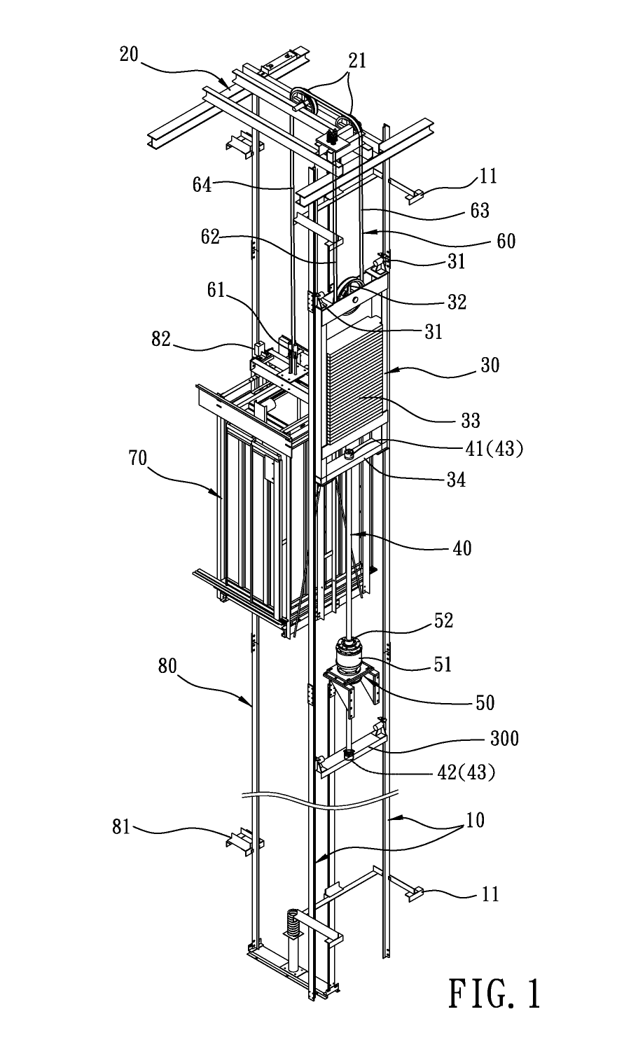

FIG. 2 is a schematic view illustrating how the cable is connected in accordance with the present invention;

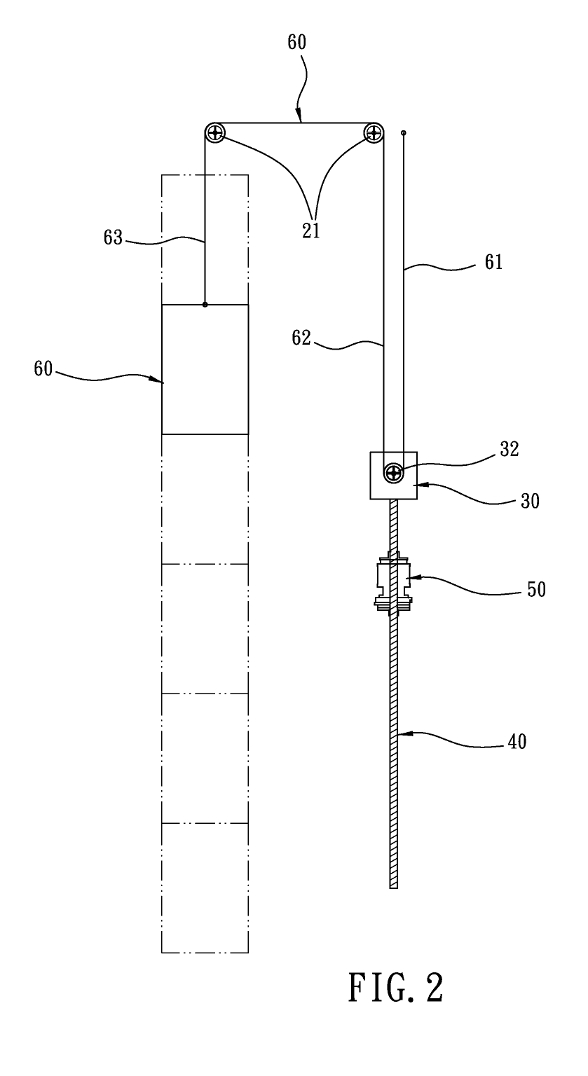

FIG. 3 is a perspective view of a power unit for the screw elevator in accordance with the present invention;

FIG. 4 is a cross-sectional view of the power unit for the screw elevator in accordance with the present invention;

FIG. 5 is a perspective view of a screw elevator in accordance with a second embodiment of the present invention;

FIG. 6 is a perspective view of a power unit for the screw elevator in accordance with the second embodiment of the present invention; and

FIG. 7 is a cross-sectional view of the power unit for the screw elevator in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

A screw elevator in accordance with a preferred embodiment of the present invention comprises a pair of counterweight guide rails 10, a beam frame 20, a counterweight frame 30, a screw 40, a power unit 50, a cable 60, a car 70 and a car guide rail 80.

The pair of counterweight guide rails 10 is disposed on a fixed wall surface by at least one guide rail bracket 11.

The beam frame 20 is an H-shaped structure made of angle steel. The beam frame 20 is disposed above and connected to the counterweight guide rails 10. The beam frame 20 is provided with a pair of deflection wheels 21.

The counterweight frame 30 is located between the pair of counterweight rails 10 by two guide shoes 31. The counterweight frame 30 is provided at the top thereof with a traction wheel 32 and further provided with an inner counterweight body 33. The counterweight frame 30 is provided at the bottom thereof with a fixing base 34 to be combined with a screw 40.

The screw 40 has an upper end to be fixed on the fixing base 34 at the bottom of the counterweight frame 30 and screwed with a fixing nut 41, and a lower end to be disposed at the lower end of the pair of counterweight guide rails 10, and at the lower end of the pair of counterweight guide rails 10 is further disposed a fixing base 300. The screw 40 is fixed on the fixing base 300 and screwed with another fixing nut 42. The two fixing nuts 41, 42 at two ends of the screw 40 each are equipped with a rubber mat 43.

The power unit 50 is fixed on a wall surface and includes a motor 51 which is assembled with the screw 40 and disposed between two ends of the travel of the counterweight frame 30. The counterweight frame 30 moves along the screw 40 to drive the car 70 to move to both ends of the travel of the counterweight frame 30. The motor 51 is a power source torque motor 51.

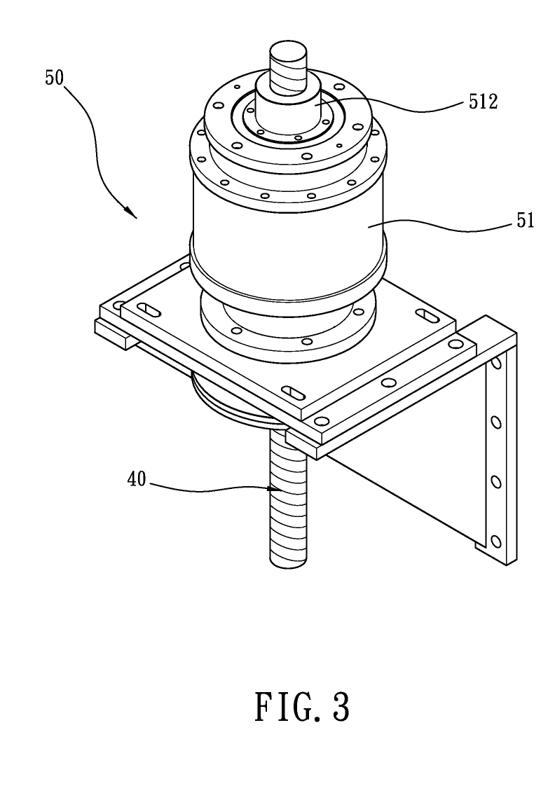

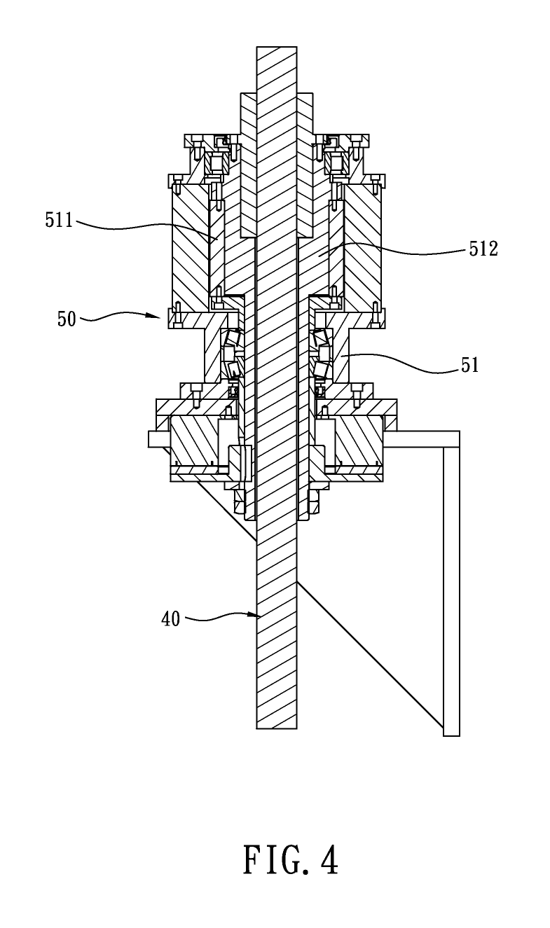

The motor 51, as shown in FIGS. 3-4, is interiorly provided with a motor rotor 511. When the motor 51 is electrified to drive the motor rotor 511 to rotate, the motor rotor 511 will drive a driving nut 512, which is disposed in the motor rotor 511 and screwed on the screw 41, to rotate. Consequently, the driving nut 512 will then drive the screw 40 to move.

The cable 60 has one end disposed on the beam frame 20 above the counterweight guide rails 10, and the other end of the cable 60 is finally connected to the car 70 after being wound around the traction wheel 32 and straddled over the deflection wheels 21. The cable 60 is fixed to the car 70 by a cable coupler 61.

The car 70 is disposed under the deflection wheels 21 and connected to the corresponding end of the cable 60. The cable 60 is disposed at the center of the top of the car 70.

The car guide rail 80 is disposed on a fixed wall surface parallel to the wall surface fixed with the counterweight guide rails 10 by at least one guide rail bracket 81 and provided for guiding the movement of the car 70. The car 70 is connected to the car guide rail 80 by a guide shoe 82.

When the car 70 is to be moved, the motor 51 of the power unit 50 will be electrified to drive the motor rotor 511 to rotate, next the driving nut 512 will be rotated to drive the screw 40 to move, and then the counterweight frame 30 will move with the screw 40 between the counterweight guide rails 10. The cable 60 combined with the counterweight frame 30 includes three sections that are a first section 62, a second section 63 and a third section 64. The first section 62 is from the position where the cable 60 is disposed on the beam frame 20 to the traction wheel 32, the second section 63 is from the traction wheel 32 to the deflection wheels 21, and the third section 64 is from the deflection wheels 21 to the car 70. When the power unit 50 drives the screw 40 to move a certain distance, the first section 62 and the second section 63 of the cable 60 will also cooperatively move the same certain distance, but the third section 64 will move a distance that is two times as long as the distance that the screw 40 is moved.

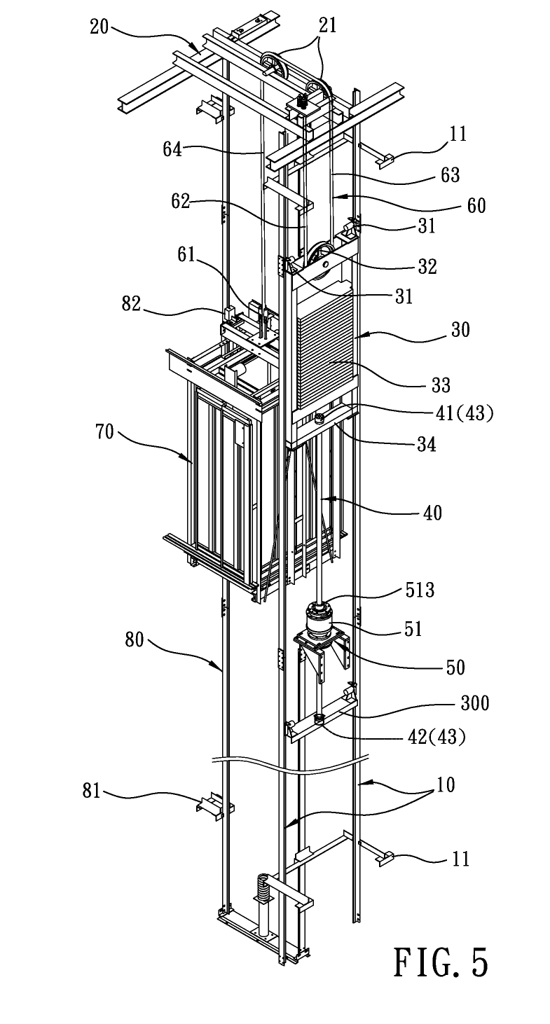

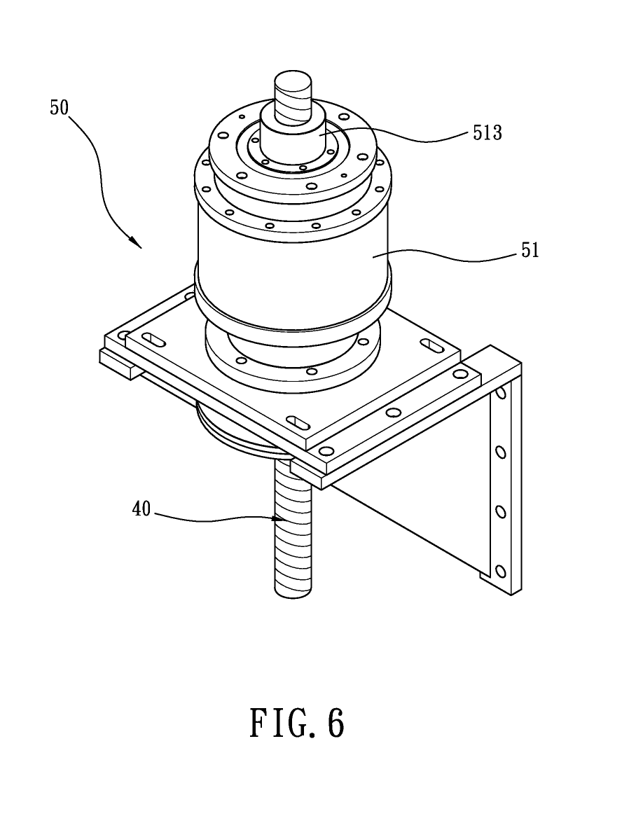

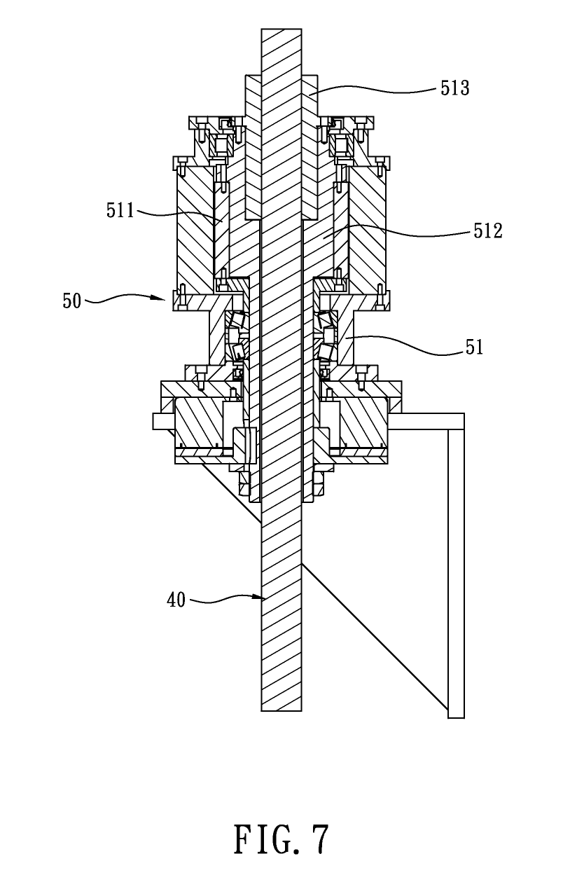

In a power unit 50 in accordance with another embodiment of the present invention, as shown in FIGS. 5-7, the motor 51 employs the motor rotor 511 and the driving nut 512 to drive the screw 40, and the driving nut 512 is equipped with a sleeve 513 in such a manner that when the motor 51 needs maintenance and repair, the driving nut 512 and the sleeve 513 can be disconnected for maintaining and repairing the motor 51 only without disassembling the screw 40, thus facilitating maintenance and repair.

The present invention has the following advantages:

1. The power unit 50 drives the car 70 to move upwards and downwards by using the cable 60 combined at the center of the top of the car 70, that is the center-of-gravity of the car 70, so that although the principle of screw is employed, the car 70 is subjected to a relatively smaller torque and shares the pulling force and weight evenly, thus making the whole elevator durable and the upward/downward movement of the elevator smooth.

2. The screw 40 is installed within the space of the counterweight guide rails 10 without providing extra installation space, so that the overall structure layout is relatively simple and the design and manufacturing cost can be consequently reduced.

3. The length of the screw 40 is just half of the total travel of the car 70, so that the screw 40 is relatively short, thus simplifying the production, and the travel of the screw elevator of the present invention is relatively long, thus widening the application range.

4. The power unit 50 includes the motor 51 which is interiorly provided with the motor rotor 511, and the driving nut 512 is disposed in the motor rotor 511 and screwed on the screw 40, so that the screw elevator of the present invention is not required to employ a complex-structured deceleration mechanism, thus having the advantages such as low cost of parts, occupying less space, simple design, easy to install, etc.

5. The power unit 50 is equipped with a sleeve 513 between the driving nut 512 and the screw 40, so that if the motor 51 needs maintenance and repair, the nut 512 and the sleeve 513 can be disconnected to facilitate the maintenance and repair of the motor 51 without disassembling the screw 40.

While we have shown and described various embodiments in accordance with the present invention, it is clear to those skilled in the art that further embodiments may be made without departing from the scope of the present invention.

What is claimed is:

1. A screw elevator comprising:
a pair of counterweight guide rails disposed on a fixed wall surface;
a pair of deflection wheels disposed above the pair of counterweight guide rails;
a counterweight frame provided at a top thereof with a traction wheel and at a bottom thereof with a screw, the counterweight frame being further provided with a inner counterweight body;
the screw having an upper end fixed on the bottom of the counterweight frame;
a power unit being fixed on a wall surface and including a motor that is assembled with the screw;
the motor being interiorly provided with a motor rotor which is interiorly provided a driving nut to be screwed on the screw, the motor rotor being provided to drive the driving nut to rotate so as to drive the screw to move;
a cable having one end fixed at a position above the pair of counterweight guide rails, and the other end of the cable being finally connected to a car after being wound around the traction wheel and straddled over the deflection wheels;
the car being disposed under the deflection wheels and connected to the cable; and
a car guide rail disposed on a fixed wall surface parallel to the fixed wall surface fixed with the pair of counterweight guide rails for guiding movement of the car.

2. The screw elevator as claimed in claim 1 further comprising a beam frame above the counterweight guide rails, the deflection wheels being disposed on the beam frame.

3. The screw elevator as claimed in claim 1, wherein the counterweight frame is located between the counterweight guide rails by two guide shoes.

4. The screw elevator as claimed in claim 1, wherein the screw has the other end disposed at a lower end of the pair of counterweight guide rails.

5. The screw elevator as claimed in claim 1, wherein the counterweight guide rails are disposed on the fixed wall surface by at least one guide rail bracket.

6. The screw elevator as claimed in claim 1, wherein the counterweight frame is provided with a fixing base for combining with the upper end of the screw, which is screwed with a fixing nut, the pair of counterweight guide rails is further provided with a fixing base at the lower end thereof, and the other end of the screw is fixed on the fixing base at the lower end of the pair of counterweight guide rails and screwed with another fixing nut.

7. The screw elevator as claimed in claim 6, wherein the fixing nuts at two ends of the screw each are equipped with a rubber mat.

8. The screw elevator as claimed in claim 1, wherein the motor of the power unit is disposed between two ends of a travel of the counterweight frame, the counterweight frame moves along the screw to drive the car to move to both ends of the travel of the counterweight frame.

9. The screw elevator as claimed in claim 1, wherein the one end of the cable is disposed on the beam frame above the counterweight guide rails.

10. The screw elevator as claimed in claim 1, wherein the cable includes three sections that are a first section, a second section and a third section, the first section is from the position where the cable is disposed on the beam frame to the traction wheel, the second section is from the traction wheel to the deflection wheels, and the third section is from the deflection wheels to the car, a length of each of the first section, second section and the third section changes with movement of the counterweight frame.

11. The screw elevator as claimed in claim 10, wherein when the power unit drives the screw to move a certain distance, the first section and the second section of the cable will also cooperatively move the same certain distance, but the third section will move a distance that is two times as long as the distance that the screw is moved.

12. A screw elevator comprising:
a pair of counterweight guide rails disposed on a fixed wall surface;
a pair of deflection wheels disposed above the pair of counterweight guide rails;
a counterweight frame provided at a top thereof with a traction wheel and at a bottom thereof with a screw, the counterweight frame being further provided with an inner counterweight body;
the screw having an upper end fixed on the bottom of the counterweight frame;
a power unit being fixed on a wall surface and including a motor that is assembled with the screw;
the motor being interiorly provided with a motor rotor which is interiorly provided with a driving nut and a sleeve, that are provided for accommodation of the screw, so that when the motor is electrified to drive the motor rotor to rotate, the motor rotor will drive the driving nut to rotate so as to drive the screw to move;
a cable having one end fixed at a position above the pair of counterweight guide rails, and the other end of the cable being finally connected to a car after being wound around the traction wheel and straddled over the deflection wheels;
the car being disposed under the deflection wheels and connected to the cable; and
a car guide rail disposed on a fixed wall surface parallel to the fixed wall surface fixed with the pair of counterweight guide rails for guiding movement of the car.

13. The screw elevator as claimed in claim 12 further comprising a beam frame above the counterweight guide rails, the deflection wheels being disposed on the beam frame.

14. The screw elevator as claimed in claim 12, wherein the counterweight frame is located between the counterweight guide rails by two guide shoes.

15. The screw elevator as claimed in claim 12, wherein the screw has the other end disposed at a lower end of the pair of counterweight guide rails.

16. The screw elevator as claimed in claim 12, wherein the counterweight guide rails are disposed on the fixed wall surface by at least one guide rail bracket.

17. The screw elevator as claimed in claim 12, wherein the counterweight frame is provided with a fixing base for combining with the upper end of the screw, which is screwed with a fixing nut, the pair of counterweight guide rails is further provided with a fixing base at the lower end thereof, and the other end of the screw is fixed on the fixing base at the lower end of the pair of counterweight guide rails and screwed with another fixing nut.

18. The screw elevator as claimed in claim 12, wherein the motor of the power unit is disposed between two ends of a travel of the counterweight frame, the counterweight frame moves along the screw to drive the car move to both ends of the travel of the counterweight frame.

19. The screw elevator as claimed in claim 12, wherein the cable includes three sections that are a first section, a second section and a third section, the first section is from the position where the cable is disposed on the beam frame to the traction wheel, the second section is from the traction wheel to the deflection wheels, and the third section is from the deflection wheels to the car, a length of each of the first section, second section and the third section changes with movement of the counterweight frame.

20. The screw elevator as claimed in claim 19, wherein when the power unit drives the screw to move a certain distance, the first section and the second section of the cable will also cooperatively move the same certain distance, and the third section will move a distance that is two times as long as the distance that the screw is moved.
